(19) United States
(12) Patent Application Publication
(10) Pub. No.: US 2024/0114974 A1
(43) Pub. Date: Apr. 11, 2024

(54) AEROSOL-GENERATING DEVICE AND SYSTEM

(71) Applicant: KT&G CORPORATION, Daejeon (KR)

(72) Inventor: Moonbong LEE, Seoul (KR)

(73) Assignee: KT&G CORPORATION, Daejeon (KR)

(21) Appl. No.: 18/280,445

(22) PCT Filed: Dec. 16, 2021
(86) PCT No.: PCT/KR2021/019206

§ 371 Date: Sep. 5, 2023

(30) Foreign Application Priority Data
Dec. 22, 2020 (KR) 10-2020-0181202

(51) Int. Cl. A24F 40/57; A24D 1/02; A24D 1/20; A24F 40/20; A24F 40/51; A24F 40/53; H05B 3/42

(52) U.S. Cl. CPC A24F 40/57; A24D 1/02; A24D 1/20; A24F 40/20; A24F 40/51; A24F 40/53; H05B 3/42

(57) ABSTRACT

An aerosol-generating device and system are disclosed. The aerosol-generating device includes a heater for heating an aerosol-generating material, a power supply for supplying electric power to the heater, and a controller for controlling the amount of electric power supplied to the heater. In a first section, the controller controls the amount of electric power supplied to the heater such that the aerosol-generating material is heated to a first temperature during a first time period. In a second section, after the first section, the controller controls the amount of electric power supplied to the heater such that the aerosol-generating material is heated to a second temperature, which is higher than the first temperature. In a third section, after the second section, the controller controls the amount of electric power supplied to the heater such that the aerosol-generating material is maintained at a third temperature, which is lower than the second temperature.

### TECHNICAL FIELD

The present disclosure relates to an aerosol-generating device and system, and more particularly to an aerosol-generating device and system capable of removing moisture present in an aerosol-generating article by heating the inside of the aerosol-generating article prior to a puff by a user.

### BACKGROUND ART

An aerosol-generating device is a device that extracts certain components from a medium or a material by forming an aerosol. The medium may contain a multicomponent material. The material contained in the medium may be a multicomponent flavoring material. For example, the material contained in the medium may include a nicotine component, an herbal component, and/or a coffee component. Recently, research on heated aerosol-generating articles or heated aerosol-generating devices has been actively conducted.

When a user inhales an aerosol generated from a heated aerosol-generating article in a high-temperature and high-humidity environment, for example, in a high-temperature and high-humidity area or during a high-temperature and high-humidity period, the user may experience a high temperature in the mouth. This phenomenon is caused by vapor present in the aerosol-generating article in the high-temperature and high-humidity environment, and is particularly severe at the time of the first puff by the user.

Water has a higher specific heat than air, and thus has a greater heat capacity than air at the same temperature. Therefore, when a user inhales an aerosol having high moisture content, the user may experience a higher temperature than when inhaling air at the same temperature. Therefore, there is a need for a method of removing (drying) moisture present in an aerosol-generating article prior to the first puff by the user.

### DISCLOSURE OF INVENTION

### Technical Problem

The present disclosure has been made in order to solve the above problems, and it is an object of the present disclosure to provide an aerosol-generating device and system capable of removing moisture present in an aerosol-generating article by heating the inside of the aerosol-generating article prior to a puff by a user.

In addition, it is another object of the present disclosure to provide an aerosol-generating device and system capable of removing moisture present in an aerosol-generating article through a heating method suitable for the type of aerosol-generating article.

In addition, it is still another object of the present disclosure to provide an aerosol-generating device and system capable of removing only moisture present in an aerosol-generating article without loss of an aerosol-generating material by controlling the temperature range of a heater for heating the inside of the aerosol-generating article.

### Solution to Problem

In accordance with an aspect of the present disclosure, the above and other objects can be accomplished by the provision of an aerosol-generating device including a heater configured to heat an aerosol-generating material, a power supply configured to supply electric power to the heater, and a controller configured to control the electric power to be supplied to the heater. In a first section, the controller is configured to control the electric power to be supplied to the heater such that the aerosol-generating material is heated to a first temperature during a first time period. In a second section, after the first section, the controller is configured to control the electric power to be supplied to the heater such that the aerosol-generating material is heated to a second temperature, which is higher than the first temperature. In a third section, after the second section, the controller is configured to control the electric power to be supplied to the heater such that the aerosol-generating material is maintained at a third temperature, which is lower than the second temperature.

In accordance with another aspect of the present disclosure, the first temperature may be higher than an ambient temperature.

In accordance with another aspect of the present disclosure, the first temperature may be lower than the volatilization temperature of the aerosol-generating material.

In accordance with another aspect of the present disclosure, the aerosol-generating device may further include a humidity sensor configured to measure ambient humidity. The controller may determine the first temperature and the first time period based on the ambient humidity measured by the humidity sensor.

In accordance with another aspect of the present disclosure, based on increase in the ambient humidity, the controller may increase at least one of the first temperature or the first time period.

In accordance with another aspect of the present disclosure, based on the ambient humidity being less than or equal to a preset value, the controller may omit control in the first section, and may perform control for heating the aerosol-generating material to the second temperature in the second section.

In accordance with another aspect of the present disclosure, the aerosol-generating device may further include an identification sensor. The controller may identify an aerosol-generating article containing the aerosol-generating material based on a signal of the identification sensor.

In accordance with another aspect of the present disclosure, the controller may determine the first temperature and the first time period based on the type of the identified aerosol-generating article.

In accordance with another aspect of the present disclosure, the heater may include at least one of an induction heater or an electro-resistive heater, and the controller may control the amount of electric power supplied to the induction heater or the electro-resistive heater based on the type of the identified aerosol-generating article.

In accordance with another aspect of the present disclosure, the controller may determine whether the identified aerosol-generating article includes a thermally conductive wrapper according to the type of the identified aerosol-generating article, and based on the identified aerosol-generating article being determined to include the thermally conductive wrapper, the controller may perform control such that the induction heater is heated.

In accordance with another aspect of the present disclosure, the controller may determine whether the identified aerosol-generating article includes a thermally conductive wrapper according to the type of the identified aerosol-generating article, and based on the identified aerosol-generating article being determined not to include the thermally conductive wrapper, the controller may perform control such that the electro-resistive heater is heated.

In accordance with another aspect of the present disclosure, in a fourth section, after the third section, the controller may control the amount of electric power supplied to the heater such that the aerosol-generating material is gradually heated to a fourth temperature, which is higher than the third temperature.

In accordance with another aspect of the present disclosure, the aerosol-generating device may further include a flow sensor or a pressure sensor. The controller may sense the number of user puffs via the flow sensor or the pressure sensor. based on the number of user puffs being greater than or equal to a predetermined number of times, or based on a second time period elapsing since heating the aerosol-generating material toward the first temperature started, the controller may stop supply of electric power to the heater to stop heating the aerosol-generating material.

In accordance with another aspect of the present disclosure, the first section may include a heating section and a maintenance section following the heating section, and the maintenance section may include a first maintenance section and a second maintenance section following the first maintenance section. In the heating section, the controller may perform control such that a first magnitude of electric power is supplied to the heater to heat the aerosol-generating material to the first temperature. In the first maintenance section, the controller may perform control such that electric power is not supplied to the heater. In the second maintenance section, the controller may perform control such that a second magnitude of electric power is supplied to the heater, the second magnitude of electric power is smaller than the first magnitude of electric power.

In accordance with another aspect of the present disclosure, the controller may determine whether an event related to generation of an aerosol occurs. When an event related to generation of the aerosol occurs, the controller may control the electric power to be supplied to the heater such that the aerosol-generating material is heated to the first temperature during the first time period in the first section.

In accordance with another aspect of the present disclosure, there is provided an aerosol-generating system including an aerosol-generating article containing an aerosol-generating material and an aerosol-generating device configured to heat the aerosol-generating material. The aerosol-generating device includes a heater configured to heat the aerosol-generating material, a power supply configured to supply electric power to the heater, and a controller configured to control the electric power to be supplied to the heater. In a first section, the controller is configured to control the electric power to be supplied to the heater such that the aerosol-generating material is heated to a first temperature during a first time period. In a second section, after the first section, the controller is configured to control the electric power to be supplied to the heater such that the aerosol-generating material is heated to a second temperature, which is higher than the first temperature. In a third section, after the second section, the controller is configured to control the electric power to be supplied to the heater such that the aerosol-generating material is maintained at a third temperature, which is lower than the second temperature.

### Advantageous Effects of Invention

According to at least one of embodiments of the present disclosure, it is possible to remove moisture present in an aerosol-generating article by heating the inside of the aerosol-generating article prior to a puff by a user.

In addition, according to at least one of embodiments of the present disclosure, it is possible to remove only moisture present in an aerosol-generating article without loss of an aerosol-generating material by controlling the temperature range within which the aerosol-generating material is heated.

In addition, according to at least one of embodiments of the present disclosure, it is possible to prevent a user from experiencing a high temperature at the time of a puff, thereby increasing user satisfaction.

In addition, according to at least one of embodiments of the present disclosure, it is possible to heat an aerosol-generating material by performing a heating method of a heater included in a conventional aerosol-generating device, thereby making it possible to remove moisture present in an aerosol-generating article utilizing the conventional aerosol-generating device without a separate heating device.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features and other advantages of the present disclosure will be more clearly understood from the following detailed description taken in conjunction with the accompanying drawings, in which:

FIGS. 1 to 3 are views showing examples in which an aerosol-generating article is inserted into an aerosol-generating device according to an embodiment of the present disclosure;

FIG. 4 is a view showing an example of the aerosol-generating article;

FIG. 5 is a block diagram of an aerosol-generating device according to an embodiment of the present disclosure;

FIGS. 6 to 9 are graphs showing the heater temperature control characteristics of an aerosol-generating device according to embodiments of the present disclosure;

FIG. 10 is a view showing an example of the aerosol-generating article used in the aerosol-generating device according to embodiments of the present disclosure;

FIGS. 11 and 12 are graphs showing the characteristics for controlling supply of electric power to a heater in a first section according to embodiments of the present disclosure; and

FIGS. 13 and 14 are flowcharts of a heater control method of the aerosol-generating device according to embodiments of the present disclosure.

### BEST MODE FOR CARRYING OUT THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

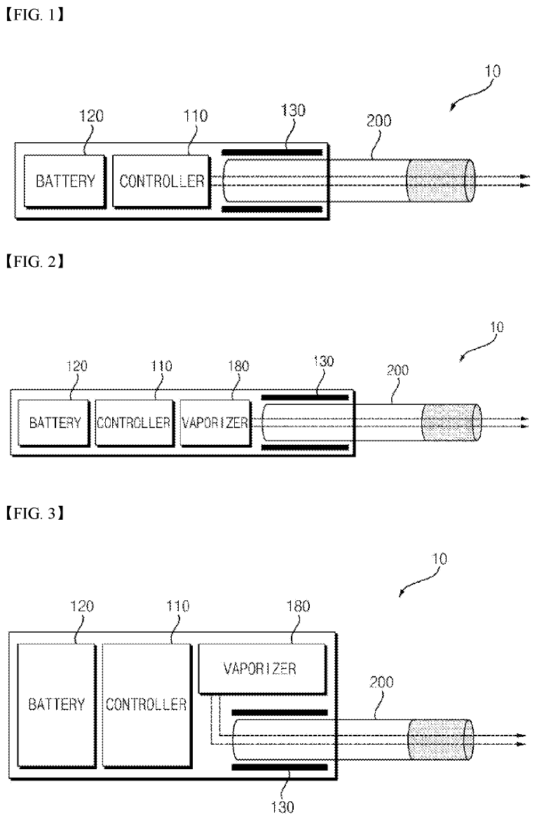

FIGS. 1 to 3 are views showing examples in which an aerosol-generating article is inserted into an aerosol-generating device according to an embodiment of the present disclosure.

Referring to FIG. 1, the aerosol-generating device 100 includes a power supply 120, a controller 110, and a heater 130. Referring to FIGS. 2 and 3, the aerosol-generating device 100 further includes a vaporizer 180. Also, an aerosol-generating article 200 may be inserted into an inner space in the aerosol-generating device 100. It will be understood by those skilled in the art that other general-purpose components may be further included in the aerosol-generating device 100, in addition to the components shown in FIGS. 1 to 3.

FIG. 1 illustrates the case in which the power supply 120, the controller 110, and the heater 130 are arranged in series. FIG. 2 illustrates the case in which the power supply 120, the controller 110, the vaporizer 180, and the heater 130 are arranged in series. FIG. 3 illustrates the case in which the vaporizer 180 and the heater 130 are arranged in parallel. However, the internal structure of the aerosol-generating device 100 is not limited to the structures illustrated in FIGS. 1 to 3. The arrangement of the power supply 120, the controller 110, the heater 130, and the vaporizer 180 may vary.

When the aerosol-generating article 200 is inserted into the aerosol-generating device 100, the aerosol-generating device 100 may operate at least one of the heater 130 or the vaporizer 180 in order to generate an aerosol from at least one of the aerosol-generating article 200 or the vaporizer 180. The aerosol generated by at least one of the heater 130 or the vaporizer 180 is delivered to a user through the aerosol-generating article 200. Even when the aerosol-generating article 200 is not inserted into the aerosol-generating device 100, the aerosol-generating device 100 may supply electric power to the heater 130 as needed.

The power supply 120 supplies electric power to be used for the aerosol-generating device 100 to operate. For example, the power supply 120 may supply electric power to heat the heater 130 or the vaporizer 180, and may supply electric power required in order for the controller 110 to operate. Also, the power supply 120 may supply electric power required in order for a display, a sensor, a motor, etc. mounted in the aerosol-generating device 100 to operate.

The power supply 120 may supply electric power to the heater 130. The power supply 120 may be electrically connected to the heater 130. The magnitude of the electric power supplied to the heater 130 may be adjusted by the controller 110.

The power supply 120 may receive electric energy from an external separate power source, and may deliver the electric energy to the heater 130 to supply a necessary amount of electric power to the heater 130. In this case, the power supply 120 may be connected to cables, such as a power cable and a Universal Serial Bus (USB) cable. To this end, the power supply 120 may include a power terminal, a USB terminal, and the like. The power supply 120 may be wirelessly connected to the external power source, and may receive energy via wireless communication. To this end, the power supply 120 may include a wireless communication module.

The controller 110 controls the overall operation of the aerosol-generating device 100. In detail, the controller 110 controls the operation not only of the power supply 120, the heater 130, and the vaporizer 180, but also of other components included in the aerosol-generating device 100. Also, the controller 120 may check the state of each of the components of the aerosol-generating device 100 to determine whether the aerosol-generating device 100 is in an operable state.

The controller 110 may include at least one processor. The processor can be implemented as an array of a plurality of logic gates, or can be implemented as a combination of a general-purpose microprocessor and a memory in which a program executable in the microprocessor is stored. Also, the processor can be implemented in other forms of hardware.

The heater 130 may be heated by the electric power supplied from the power supply 120, or may inductively heat a susceptor. For example, when the aerosol-generating article 200 is inserted into the aerosol-generating device 100, the heater 130 may be located outside the aerosol-generating article 200, or may be inserted into the center of the aerosol-generating article 200. Thus, the heater 130 may increase the temperature of an aerosol-generating material in the aerosol-generating article 200.

The heater 130 may be an electro-resistive heater. For example, the heater 130 may include an electrically conductive track, and may be heated as current flows through the electrically conductive track. However, the heater 130 is not limited to the example described above, and any other type of heater may be used, so long as the same is capable of being heated to a desired temperature. Here, the desired temperature may be preset in the aerosol-generating device 100, or may be set to a temperature desired by a user.

The heater 130 may be an induction heater. In detail, the heater 130 may include an electrically conductive coil for heating the aerosol-generating article 200 in an induction-heating method, and the aerosol-generating article 200 may include a susceptor, which may be heated by the induction heater.

For example, the heater 130 may include a tube-type heating element, a plate-type heating element, a needle-type heating element, or a rod-type heating element, and may heat the inside or the outside of the aerosol-generating article 200 according to the shape of the heating element.

The aerosol-generating device 100 may include a plurality of heaters 130. Here, the plurality of heaters 130 may be inserted into the aerosol-generating article 200, or may be disposed outside the aerosol-generating article 200. Also, some of the plurality of heaters 130 may be inserted into the aerosol-generating article 200, and others may be disposed outside the aerosol-generating article 200. In addition, the shape of the heater 130 is not limited to the shapes illustrated in FIGS. 1 to 3, and the heater 130 may be formed in any of various shapes.

The vaporizer 180 may generate an aerosol by heating a liquid composition. The generated aerosol may pass through the aerosol-generating article 200 to be delivered to a user. The aerosol generated by the vaporizer 180 may move along an air flow passage in the aerosol-generating device 100. The air flow passage may be configured such that the aerosol generated by the vaporizer 180 passes through the aerosol-generating article 200 to be delivered to the user.

The vaporizer 180 may include a liquid storage (not shown), a liquid delivery element (not shown), and a heating element (not shown), but the present disclosure is not limited thereto. For example, the liquid storage, the liquid delivery element, and the heating element may be included in the aerosol-generating device 100 as independent modules.

The liquid storage may store a liquid composition. For example, the liquid composition may be a liquid including a tobacco-containing material having a volatile tobacco flavor component, or may be a liquid including a non-tobacco material. The liquid storage may be formed to be detachable from the vaporizer 180, or may be formed integrally with the vaporizer 180.

The liquid composition may include water, a solvent, ethanol, plant extracts, spices, flavorings, or a vitamin mixture. The spices may include menthol, peppermint, spearmint oil, and various fruit-flavored ingredients, but the present disclosure is not limited thereto. The flavorings may include ingredients capable of providing various flavors or tastes to a user. The vitamin mixture may be a mixture of at least one of vitamin A, vitamin B, vitamin C, or vitamin E, but the present disclosure is not limited thereto. Also, the liquid composition may include an aerosol-forming agent, such as glycerin or propylene glycol.

The liquid delivery element may deliver the liquid composition in the liquid storage to the heating element. For example, the liquid delivery element may be a wick made of, for example, cotton fiber, ceramic fiber, glass fiber, or porous ceramic, but the present disclosure is not limited thereto.

The heating element is an element for heating the liquid composition delivered by the liquid delivery element. For example, the heating element may be a metal heating wire, a metal hot plate, a ceramic heater, or the like, but the present disclosure is not limited thereto. In addition, the heating element may be configured as a conductive filament such as a nichrome wire, and may be disposed in a manner of being wound around the liquid delivery element. The heating element may be heated by the current supplied thereto, and may transfer heat to the liquid composition, which is in contact with the heating element, thereby heating the liquid composition.

The vaporizer 180 may be referred to as a cartomizer or an atomizer, but the present disclosure is not limited thereto.

The aerosol-generating device 100 may further include general-purpose components, in addition to the power supply 120, the controller 110, the heater 130, and the vaporizer 180. For example, the aerosol-generating device 100 may include a display capable of outputting visual information and/or a motor for outputting haptic information. Also, the aerosol-generating device 100 may include at least one sensor (a puff detection sensor, a temperature detection sensor, an aerosol-generating article insertion detection sensor, etc.). Also, the aerosol-generating device 100 may be formed to have a structure in which, when the aerosol-generating article 200 is inserted into the aerosol-generating device 100, external air may be introduced thereinto, or internal gas may be discharged therefrom.

Although not illustrated in FIGS. 1 to 3, the aerosol-generating device 100 may constitute a system together with a separate cradle. For example, the cradle may be used to charge the power supply 120 of the aerosol-generating device 100. For example, the heater 130 may be heated in the state in which the cradle and the aerosol-generating device 100 are coupled to each other.

The aerosol-generating article 200 may be similar to a general combustible cigarette. For example, the aerosol-generating article 200 may be divided into a first portion including an aerosol-generating material and a second portion including a filter. Alternatively, the second portion of the aerosol-generating article 200 may also include an aerosol-generating material. For example, a granular or capsular aerosol-generating material may be inserted into the second portion.

The entirety of the first portion may be inserted into the aerosol-generating device 100, and the second portion may be exposed to the outside. Alternatively, only a portion of the first portion may be inserted into the aerosol-generating device 100. Alternatively, the entirety of the first portion and a portion of the second portion may be inserted into the aerosol-generating device 100.

The user may inhale the aerosol in the state of holding the second portion in the mouth. At this time, the aerosol may be generated as external air passes through the first portion, and the generated aerosol may pass through the second portion to be introduced into the mouth of the user.

The external air may flow into the aerosol-generating device 100 through at least one air passage formed in the aerosol-generating device 100. Opening/closing of the air passage and/or the size of the air passage formed in the aerosol-generating device 100 may be adjusted by the user. Accordingly, the amount of smoke and a smoking sensation may be adjusted by the user. The external air may also flow into the aerosol-generating article 200 through at least one hole formed in the surface of the aerosol-generating article 200.

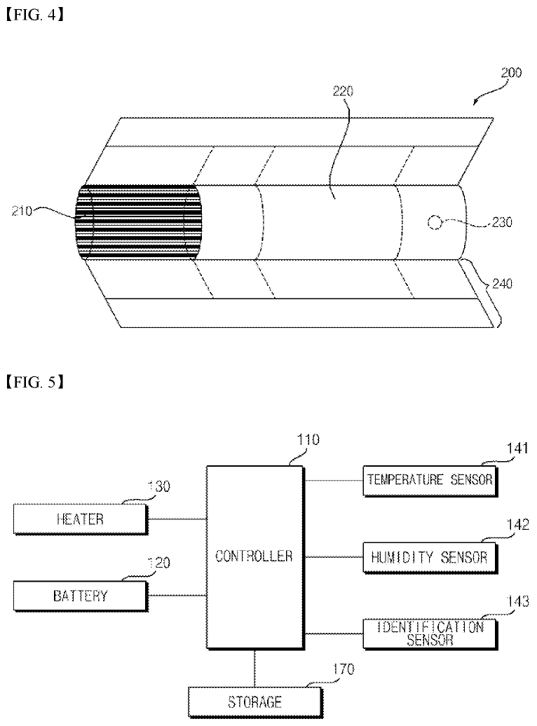

FIG. 4 is a view showing an example of the aerosol-generating article.

Referring to FIG. 4, the aerosol-generating article 200 includes a tobacco rod 210 and a filter rod 220. The first portion described above with reference to FIGS. 1 to 3 includes the tobacco rod 210, and the second portion includes the filter rod 220.

Although it is illustrated in FIG. 4 that the filter rod 220 is composed of a single segment, the present disclosure is not limited thereto. The filter rod 220 may be composed of a plurality of segments.

For example, the filter rod 220 may include a first segment configured to cool an aerosol and a second segment configured to remove a predetermined component included in the aerosol. In addition, the filter rod 220 may further include at least one segment configured to perform other functions, as needed.

The aerosol-generating article 200 may be packed using at least one wrapper 240. The wrapper 240 may have at least one hole formed therein to allow external air to be introduced thereinto or to allow internal gas to be discharged therefrom. The aerosol-generating article 200 may be packed using one wrapper 240, or may be doubly packed using two or more wrappers 240. For example, the tobacco rod 210 may be packed using a first wrapper, and the filter rod 220 may be packed using a second wrapper. The tobacco rod 210 and the filter rod 220, which are individually packed using separate wrappers, may be coupled to each other, and the entirety of the aerosol-generating article 200 may be packed using a third wrapper. When each of the tobacco rod 210 and the filter rod 220 is composed of a plurality of segments, each segment may be packed using a separate wrapper. Also, the entirety of the aerosol-generating article 200, formed by coupling segments, each of which is packed using a separate wrapper, to each other, may be packed using another wrapper.

The tobacco rod 210 includes an aerosol-generating material. For example, the aerosol-generating material may include at least one of glycerin, propylene glycol, ethylene glycol, dipropylene glycol, diethylene glycol, triethylene glycol, tetraethylene glycol, or oleyl alcohol, but the present disclosure is not limited thereto. Also, the tobacco rod 210 may include other additives, such as a flavoring agent, a wetting agent, and/or an organic acid.

A flavoring liquid, such as menthol or a moisturizer, may be injected into and added to the tobacco rod 210.

The tobacco rod 210 may be manufactured in various forms. For example, the tobacco rod 210 may be formed as a sheet or a strand. The tobacco rod 210 may be formed as shredded tobacco, which is formed by cutting a tobacco sheet into tiny bits.

The tobacco rod 210 may be surrounded by a thermally conductive material. For example, the thermally conductive material may be a metal foil such as an aluminum foil, but the present disclosure is not limited thereto. In one example, the thermally conductive material surrounding the tobacco rod 210 may uniformly distribute heat transferred to the tobacco rod 210, thereby improving conduction of the heat applied to the tobacco rod and thus improving the taste of the tobacco. The thermally conductive material surrounding the tobacco rod 210 may function as a susceptor that is heated by the induction heater. The tobacco rod 210 may further include an additional susceptor, in addition to the thermally conductive material surrounding the tobacco rod 210.

The filter rod 220 may be a cellulose acetate filter. The filter rod 220 may be formed in any of various shapes. For example, the filter rod 220 may be a cylinder-type rod or a hollow tube-type rod. Also, the filter rod 220 may be a recess-type rod. When the filter rod 220 is composed of a plurality of segments, at least one of the plurality of segments may be formed in a different shape.

The filter rod 220 may be formed to generate flavors. In one example, a flavoring liquid may be injected into the filter rod 220, or a separate fiber coated with a flavoring liquid may be inserted into the filter rod 220.

The filter rod 220 may include at least one capsule 230. Here, the capsule 230 may function to generate a flavor, or may function to generate an aerosol. For example, the capsule 230 may have a structure in which a liquid containing a flavoring material is wrapped with a film. The capsule 230 may have a spherical or cylindrical shape, but the present disclosure is not limited thereto.

When the filter rod 220 includes a segment configured to cool the aerosol, the cooling segment may be made of a polymer material or a biodegradable polymer material. For example, the cooling segment may be made of pure polylactic acid alone, but the present disclosure is not limited thereto. Alternatively, the cooling segment may be formed as a cellulose acetate filter having a plurality of holes formed therein. However, the cooling segment is not limited to the above-described example, and any other type of cooling segment may be used, so long as the same is capable of cooling the aerosol.

Although not illustrated in FIG. 4, the aerosol-generating article 200 may further include a front-end filter. The front-end filter may be located at the side of the tobacco rod 210 that faces the filter rod 220. The front-end filter may prevent the tobacco rod 210 from becoming detached outwards, and may prevent a liquefied aerosol from flowing into the aerosol-generating device from the tobacco rod 210 during inhalation by the user.

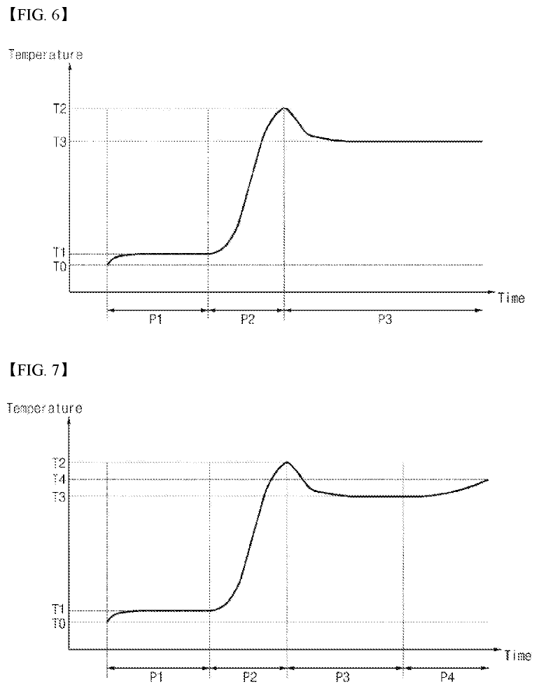

FIG. 5 is a block diagram of an aerosol-generating device according to an embodiment of the present disclosure.

Referring to FIG. 5, the aerosol-generating device 100 may include a controller 110, a power supply 120, a heater 130, and a storage 170.

The controller 110 controls the power supply 120, the heater 130, and the storage 170 included in the aerosol-generating device 100. The controller 110 may control the amount of electric power supplied to the heater 130 by controlling the power supply 120.

The controller 110 may change the temperature of the aerosol-generating material of the aerosol-generating article 200 by controlling the amount of power supplied to the heater 130. The section in which the temperature of the aerosol-generating material changes may be divided into a plurality of sections. In one example, the plurality of sections may include three sections, namely a first section, a second section, and a third section. In another example, the plurality of sections may include four sections, namely first to fourth sections. The controller 110 may control the amount of electric power supplied to the heater 130 in each section so that the temperature of the aerosol-generating material increases to a specific temperature, decreases to a specific temperature, or is maintained constant.

The power supply 120 may supply electric power to the heater 130, and the magnitude of the electric power supplied to the heater 130 may be adjusted by the controller 110.

The heater 130 may be an electro-resistive heater, or may be an induction heater. The heater 130 may include a plurality of heaters including an electro-resistive heater and an induction heater.

In the case in which the heater 130 is an electro-resistive heater, when current is applied to the heater 130, the heater 130 may generate heat, and an aerosol may be generated by the aerosol-generating material, which is in contact with or is located adjacent to the heated heater 130. In the case in which the heater 130 is an induction heater, when current is applied to an electrically conductive coil of the heater 130, a susceptor, which is disposed inside the aerosol-generating article 200 or on the surface thereof or is located adjacent to the aerosol-generating article 200, may generate heat, and an aerosol may be generated by the aerosol-generating material by the heated susceptor.

Electric power may be supplied to the heater 130 using at least one of a pulse width modulation (PWM) method or a proportional-integral-differential (PID) control method.

The controller 110 may determine whether an event related to generation of the aerosol occurs.

For example, the aerosol-generating device 100 may include an input interface (not shown), and the controller 110 may determine whether an event related to generation of the aerosol occurs using the input interface. The controller 110 may receive a smoking start signal through the input interface. Upon receiving the smoking start signal, the controller 110 may determine that a request for generation of the aerosol has occurred, and may control the power supply 120 to supply electric power to the heater 130.

For example, the aerosol-generating device 100 may include a puff detection sensor (not shown), and the controller 110 may determine whether an event related to generation of the aerosol occurs using the puff detection sensor. The puff detection sensor may be a flow sensor or a pressure sensor, but the present disclosure is not limited thereto. The controller 110 may receive a puff signal from the puff detection sensor, and may determine whether a user's puff occurs based on the received puff signal. When the first puff by the user occurs, the controller 110 may determine that an event related to generation of the aerosol has occurred, and may control the power supply 120 to supply electric power to the heater 130.

The aerosol-generating device 100 may further include a temperature sensor 141.

The temperature sensor 141 may measure the temperature of the heater 130 or the temperature of the aerosol-generating material of the aerosol-generating article 200. The temperature sensor 141 may be attached to the heater 130 to measure the temperature of the heater 130 and to provide information on the measured temperature to the controller 110. The temperature sensor 141 may be located in one area of the aerosol-generating device 100 so as to be adjacent to the aerosol-generating article 200 inserted into the aerosol-generating device 100 in order to measure the temperature of the aerosol-generating article 200 and to provide information on the measured temperature to the controller 110. The controller 110 may control the amount of electric power supplied to the heater 130 based on the measured temperature of the heater 130 or the measured temperature of the aerosol-generating material of the aerosol-generating article 200.

The aerosol-generating device 100 may further include a humidity sensor 142.

The humidity sensor 142 may be attached to the aerosol-generating device 100 to measure the ambient humidity and to provide information on the measured humidity to the controller 110. The controller 110 may calculate the amount of moisture present in the aerosol-generating article 200 based on the measured ambient humidity, and may control the amount of electric power supplied to the heater 130 based on the measured ambient humidity or the calculated amount of moisture.

The aerosol-generating device 100 may further include an identification sensor 143.

The identification sensor 143 may identify the aerosol-generating article 200 inserted into the aerosol-generating device 100. The identification sensor 143 may be configured to generate a magnetic field signal of a constant frequency and to read the frequency signal of the magnetic field reflected back from the aerosol-generating article 200. In another example, the identification sensor 143 may be configured to recognize the color of the aerosol-generating article 200 or the shape of the aerosol-generating article 200, such as a band formed on the surface of the aerosol-generating article 200. In still another example, the identification sensor 143 may be configured to recognize the reflection of light, the refractive index of light, or transmittance of light. In still yet another example, the identification sensor 143 may be an optical sensor, an infrared sensor, an ultrasonic sensor, or the like. The controller 110 may identify the aerosol-generating article 200 based on a signal received from the identification sensor 143, and may control the amount of electric power supplied to the heater 130 based on the type of the identified aerosol-generating article 200.

The storage 170 stores therein various pieces of information required in order for the controller 110 to control the amount of electric power supplied to the heater 130. For example, the storage 170 may store therein at least one piece of temperature profile information, based on which the controller 110 controls the heater 130.

In the present disclosure, an aerosol-generating system may include an aerosol-generating article 200 including an aerosol-generating material and an aerosol-generating device 300 for heating the aerosol-generating article 200.

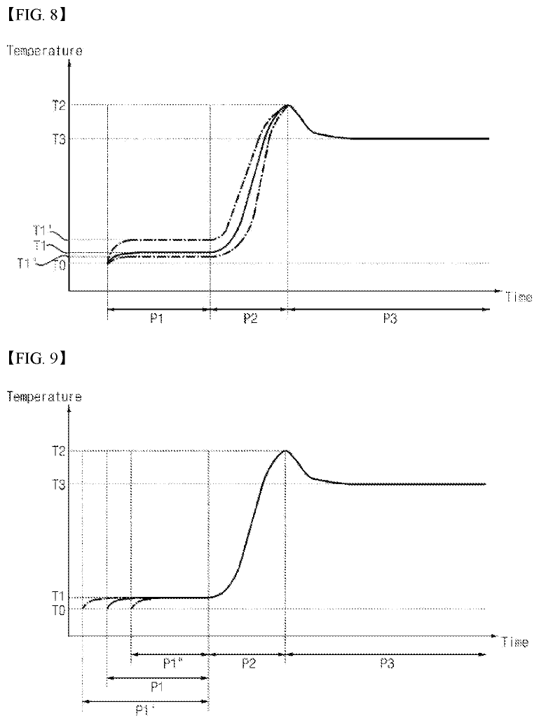

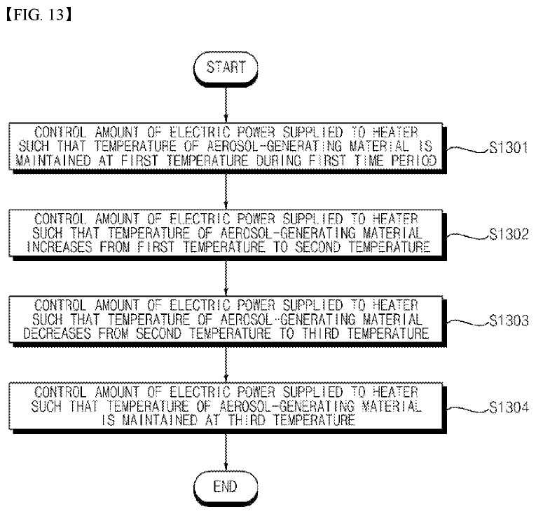

The method by which the controller 110 controls the temperature of the aerosol-generating material of the aerosol-generating article 200 in each of a plurality of sections will be described below in detail with reference to the temperature profile curves shown in FIGS. 6 to 8B and the flowcharts shown in FIGS. 11 and 12.

FIGS. 6 to 9 are graphs showing the aerosol-generating material temperature control characteristics of an aerosol-generating device according to embodiments of the present disclosure. In FIGS. 6 to 9, the horizontal axis represents time, and the vertical axis represents the temperature of the aerosol-generating material.

Referring to FIG. 6, the section in which the temperature of the aerosol-generating material changes may be divided into three sections: a first section P1, a second section P2, and a third section P3. The second section P2 is a section located after the first section P1 based on time, and the third section P3 is a section located after the second section P2 based on time.

The controller 110 may determine whether an event related to generation of the aerosol occurs. When an event related to generation of the aerosol occurs, the controller 110 may control the amount of electric power supplied to the heater 130 such that the aerosol-generating material is heated to a first temperature T1 during a first time period in the first section P1. Specifically, the controller 110 may control the amount of electric power supplied to the heater 130 such that the aerosol-generating material is heated from an ambient temperature TO or a temperature close to the same to the first temperature T1 and then the temperature of the aerosol-generating material is maintained constant at the first temperature T1 during the first time period.

In the first section P1, the controller 110 may control the supply of electric power to the heater 130 based on the PID method. Alternatively, the controller 110 may control the supply of electric power to the heater 130 based on the PWM method. Alternatively, the controller 110 may perform control based on the PWM method in the front portion of the first section P1, in which the temperature of the aerosol-generating material increases from the ambient temperature to the first temperature T1, and may perform control based on the PID method in the rear portion of the first section P1, in which the temperature of the aerosol-generating material is maintained constant at the first temperature T1. However, the method of supplying electric power to the heater 130 is not limited thereto.

The first temperature T1 may be higher than the ambient temperature. The first temperature T1 may be lower than a second temperature T2. Also, the first temperature T1 may be lower than the volatilization temperature of the aerosol-generating material included in the aerosol-generating article 200.

The first temperature T1 may range from 40 degrees Celsius to 80 degrees Celsius. In some embodiments, the first temperature T1 may be higher than 80 degrees Celsius, but the range of the first temperature T1 is not limited thereto.

In the first section P1, the temperature of the aerosol-generating material may be maintained constant at a temperature higher than the ambient temperature TO during the first time period, and a portion or the entirety of the moisture contained in the aerosol-generating article 200 inserted into the aerosol-generating device 100 may evaporate. The first section P1 may be referred to as a “preliminary preheating section” or an “aerosol-generating material drying section”

After the first section P1, the controller 110 may control the supply of electric power to the heater 130 such that the aerosol-generating material is heated from the first temperature T1 to the second temperature T2 in the second section P2. The controller 110 may control the supply of electric power to the heater 130 such that the aerosol-generating material is heated to the second temperature T2, which is higher than the first temperature T1, in the second section P2. Specifically, the controller 110 may control the supply of electric power to the heater 130 such that electric power having a higher magnitude than that applied in the first section P1 is applied to the heater 130 in order to heat the aerosol-generating material to the second temperature T2 within a relatively short time period. The length of the second section P2 may be a few seconds to several tens of seconds.

In the second section P2, the controller 110 may control the supply of electric power to the heater 130 based on the PWM method. Alternatively, the controller 110 may control the supply of electric power to the heater 130 based on the PID method. Alternatively, the controller 110 may perform control based on the PWM method in the front portion of the second section P2, and may perform control based on the PID method in the rear portion of the second section P2. However, the method of supplying electric power to the heater 130 is not limited thereto.

The second temperature T2 may be equal to or higher than the vaporization temperature of the aerosol-generating material included in the aerosol-generating article 200. For example, the second temperature T2 may be 340 degrees Celsius. In some embodiments, the second temperature T2 may be lower or higher than 340 degrees Celsius. The second temperature T2 may vary depending on the type of aerosol-generating material. The second temperature T2 may be referred to as a “target temperature”.

In the second section P2, the temperature of the aerosol-generating material sharply increases from the first temperature T1 to the second temperature T2. In the second section P2, the heater 130 heats the aerosol-generating article 200 to a temperature at which an aerosol is easily generated from the aerosol-generating article 200 inserted into the aerosol-generating device 100. In the second section P2, an aerosol may be generated from the aerosol-generating article 200 heated by the heater 130. The second section P2 may be referred to as a “preheating section”.

After the second section P2, the controller 110 may control the amount of electric power supplied to the heater 130 such that the temperature of the aerosol-generating material changes from the second temperature T2 to a third temperature T3 in the third section P3. Here, the third temperature T3 may be lower than the second temperature T2. The controller 110 may control the amount of electric power supplied to the heater 130 such that the temperature of the aerosol-generating material decreases from the second temperature T2 to the third temperature T3 and is then maintained constant at the third temperature T3 during a predetermined time period or longer.

In the third section P3, the controller 110 may control the supply of electric power to the heater 130 based on the PID method. Alternatively, the controller 110 may control the supply of electric power to the heater 130 based on the PWM method. However, the method of supplying electric power to the heater 130 is not limited thereto.

The third temperature T3 may be 300 degrees Celsius. In some embodiments, the third temperature may be lower or higher than 300 degrees Celsius. The third temperature T3 may be referred to as a “maintenance temperature”.

In the third section P3, the temperature of the aerosol-generating material decreases from the second temperature T2 to the third temperature T3 and is then maintained constant at the third temperature T3. The heater 130 constantly maintains the aerosol-generating article 200 at a temperature at which an aerosol is easily generated from the aerosol-generating article 200 inserted into the aerosol-generating device 100. In the third section P3, an aerosol may be generated from the aerosol-generating article 200 heated by the heater 130. The third section P3 may be referred to as a “temperature maintenance section”.

During the third section P3, the temperature of the aerosol-generating material may gradually and continuously decrease from the second temperature T2 to the third temperature T3, and there may be no section in which the temperature of the aerosol-generating material is maintained constant at the third temperature T3.

As described above, according to the method of controlling the heater 130 of the aerosol-generating device 100 according to an embodiment of the present disclosure, the section in which the heater 130 is controlled is divided into a plurality of sections, and the aerosol-generating material is constantly maintained at a temperature higher than the ambient temperature before being quickly heated to the target temperature, thereby making it possible to remove moisture present in the aerosol-generating article 200.

Accordingly, it is possible to remove moisture present in the aerosol-generating article prior to a puff by a user. In addition, at the time of the puff by the user, it is possible to prevent the user from experiencing a high temperature due to high-temperature moisture present in the aerosol-generating article 200 and thus to increase user satisfaction.

Referring to FIG. 7, the section in which the temperature of the aerosol-generating material changes may be divided into four sections: a first section P1, a second section P2, a third section P3, and a fourth section P4. The second section P2 is a section located after the first section P1 based on time, the third section P3 is a section located after the second section P2 based on time, and the fourth section P4 is a section located after the third section P3 based on time.

The method by which the controller 110 controls the heater 130 in the first to third sections P1 to P3 is the same as that performed in the first to third sections P1 to P3 shown in FIG. 6, and thus a duplicate description thereof will be omitted.

During the third section P3, the controller 110 may control the amount of electric power supplied to the heater 130 such that the temperature of the aerosol-generating material decreases from the second temperature T2 to the third temperature T3 and is then maintained constant at the third temperature T3 during a predetermined time period.

After the third section P3, the controller 110 may control the amount of electric power supplied to the heater 130 such that the temperature of the aerosol-generating material changes from the third temperature T3 to the fourth temperature T4 in the fourth section P4. Here, the fourth temperature T4 may be higher than the third temperature T3. The fourth temperature T4 may be equal to the second temperature T2, or may be lower than the second temperature T2.

In the fourth section P4, the controller 110 may control the supply of electric power to the heater 130 based on the PID method. The controller 110 may control the supply of electric power to the heater 130 based on the PWM method. However, the method of supplying electric power to the heater 130 is not limited thereto.

The fourth temperature T4 may be 340 degrees Celsius. In some embodiments, the fourth temperature may be lower than 340 degrees Celsius.

In the fourth section P4, the temperature of the aerosol-generating material gradually increases from the third temperature T3 to the fourth temperature T4. The heater 130 heats the aerosol-generating article 200 to a temperature at which an aerosol is easily generated from the aerosol-generating article 200 inserted into the aerosol-generating device 100. In the fourth section P4, an aerosol may be generated from the aerosol-generating article 200 heated by the heater 130. The fourth section P4 may be referred to as a “temperature increase section”.

During the third section P3, the temperature of the aerosol-generating material may decrease from the second temperature T2 to the third temperature T3, and there may be no section in which the temperature of the aerosol-generating material is maintained constant at the third temperature T3. In this case, after the temperature of the aerosol-generating material decreases to the third temperature T3 in the third section P3, the same may gradually increase from the third temperature T3 to the fourth temperature T4 in the fourth section P4.

After repeated puffs by the user, the amount of aerosol-generating material contained in the aerosol-generating article 200 may gradually decrease. The aerosol-generating device 100 may gradually increase the temperature of the aerosol-generating material in the fourth section P4, thereby preventing a decrease in the amount of the aerosol that is delivered attributable to a decrease in the amount of the aerosol-generating material contained in the aerosol-generating article 200.

Accordingly, even after many puffs by the user, it is possible to minimize a decrease in the amount of aerosol generated and thus to increase user satisfaction.

The controller 110 may sense the number of user puffs. The controller 110 may sense the number of user puffs using the puff detection sensor. Specifically, the aerosol-generating device 100 may include a flow sensor (not shown) or a pressure sensor (not shown), and the controller 110 may calculate the number of user puffs in the third section P3 or in the third and fourth sections P3 and P4 based on a signal sensed by the flow sensor or the pressure sensor, and may determine whether the number of puffs is equal to or larger than a predetermined number of times.

When the number of user puffs is equal to or larger than the predetermined number of times, or when a predetermined time period has elapsed since the aerosol-generating material started to be heated toward the first temperature, the controller 110 may stop heating the aerosol-generating material by interrupting the supply of electric power to the heater 130.

Accordingly, the temperature of the aerosol-generating material may decrease, and the aerosol generation operation by the aerosol-generating device 100 may end.

Referring to FIGS. 8 and 9, the controller 110 may determine the first temperature T1 and the first time period in the first section P1, and may control the amount of electric power supplied to the heater 130. Although FIGS. 8 and 9 illustrate the case in which the supply of electric power to the heater is controlled in the three sections shown in FIG. 6 for convenience, the following description may also apply to the case in which the supply of electric power to the heater is controlled in the four sections shown in FIG. 7.

The humidity sensor 142 of the aerosol-generating device 100 may measure ambient humidity. The humidity sensor 142 may provide information on the measured ambient humidity to the controller 110.

The controller 110 may determine the first temperature T1 and the first time period based on the information on the measured ambient humidity, and may control the amount of electric power supplied to the heater 130.

Referring to FIG. 8, the controller 110 may control the first temperature T1 based on the measured ambient humidity. For example, as the measured ambient humidity increases, the controller 110 may set the first temperature T1 to a higher level, and may control the amount of electric power supplied to the heater 130 based thereon. Also, as the measured ambient humidity decreases, the controller 110 may set the first temperature T1 to a lower level, and may control the amount of electric power supplied to the heater 130 based thereon.

The controller 110 may set a reference ambient humidity value, and may set the first temperature T1 on the basis of the reference ambient humidity value. When the measured ambient humidity is higher than the reference value, the controller 110 may set the first temperature T1 to T1′, which is higher than T1, and when the measured ambient humidity is lower than the reference value, the controller 110 may set the first temperature T1 to T1″, which is lower than T1.

Referring to FIG. 9, the controller 110 may control the first time period or the length of the first section P1 based on the measured ambient humidity. Here, the first time period may have a value proportional to the length of the first section P1. As the measured ambient humidity increases, the controller 110 may set the first time period or the length of the first section P1 to a larger value, and may control the amount of electric power supplied to the heater 130 based thereon. Also, as the measured ambient humidity decreases, the controller 110 may set the first time period or the length of the first section P1 to a smaller value, and may control the amount of electric power supplied to the heater 130 based thereon.

The controller 110 may set a reference ambient humidity value, and may set the first time period or the length of the first section P1 on the basis of the reference ambient humidity value. When the measured ambient humidity is higher than the reference value, the controller 110 may set the length of the first section P1 to P1′, which is longer than P1, and when the measured ambient humidity is lower than the reference value, the controller 110 may set the length of the first section P1 to P1″, which is shorter than P1. Although FIG. 9 illustrates only a change in the length of the first section P1 for convenience, the first time period may also change in proportion to the change in the length of the first section P1.

The controller 110 may set the first temperature T1 and the first time period based on the measured ambient humidity.

The controller 110 may set a reference ambient humidity value, and may set the first temperature T1 and the first time period (or the length of the first section P1) on the basis of the reference ambient humidity value. When the measured ambient humidity is higher than the reference value, the controller 110 may set the first temperature T1 to T1′, which is higher than T1, and may set the length of the first section P1 to P1′, which is longer than P1, and when the measured ambient humidity is lower than the reference value, the controller 110 may set the first temperature T1 to T1″, which is lower than T1, and may set the length of the first section P1 to P1″, which is shorter than P1. Here, the first time period may change in proportion to the change in the length of the first section P1.

The amount of moisture present in the aerosol-generating article 200 may vary in proportion to the ambient humidity. Therefore, the controller 110 may set at least one of the first temperature T1 or the first time period to a higher level as the ambient humidity is higher, and may set at least one of the first temperature T1 or the first time period to a lower level as the ambient humidity is lower, thereby effectively removing (drying) moisture present in the aerosol-generating article 200.

Although not illustrated in the drawings, when the ambient humidity is equal to or lower than the reference value, the controller 110 may control the amount of electric power supplied to the heater 130 such that the aerosol-generating material is heated from the ambient temperature T0 to the second temperature T2, without a section in which the aerosol-generating material is heated to the first temperature T1. That is, the controller 110 may control the amount of electric power supplied to the heater 130 such that, among the plurality of sections in which the heater 130 is controlled, control of the heater 130 in the first section is omitted, and control of the heater 130 in the second section is performed first.

When the ambient humidity is equal to or less than a certain value, even if moisture is present in the aerosol-generating article 200, the amount of moisture may be very small. Therefore, the controller 110 may omit the first section, which is the preliminary preheating section, and may immediately heat the aerosol-generating material to the target temperature, thereby reducing the time that the user needs to wait to take a puff, thus increasing user satisfaction.

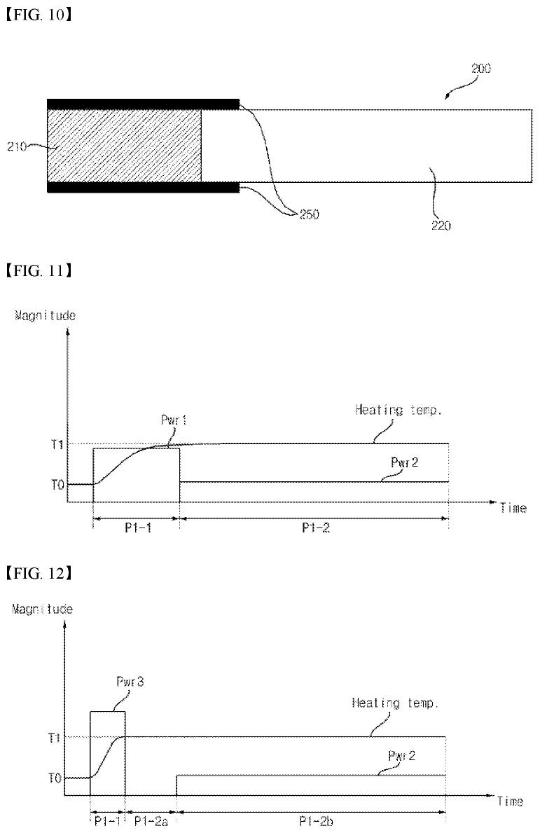

FIG. 10 is a view showing an example of the aerosol-generating article used in the aerosol-generating device according to embodiments of the present disclosure.

Referring to FIG. 10, at least a portion of the aerosol-generating article 200 may be surrounded by a wrapper (a thermally conductive wrapper) 250 including a thermally conductive material.

The tobacco rod 210 of the aerosol-generating article 200 may be surrounded by the thermally conductive wrapper 250. The thermally conductive wrapper 250 may surround all or part of the tobacco rod 210. The thermally conductive wrapper 250 may be a metal foil such as an aluminum foil, but the present disclosure is not limited thereto. The thermally conductive wrapper 250 may function as a susceptor that is heated by an induction heater. The tobacco rod 210 may further include an additional susceptor, in addition to the thermally conductive wrapper 250 surrounding the outer surface thereof.

The thermally conductive wrapper 250 may not be included in the aerosol-generating article 200.

When the aerosol-generating article 200 is inserted into the aerosol-generating device 100, the controller 110 may identify the aerosol-generating article 200. The controller 110 may identify the aerosol-generating article 200 before heating the aerosol-generating material (before the first section).

The identification sensor 143 may generate identification information on the aerosol-generating article 200. The controller 110 may identify the type of aerosol-generating article 200 based on the identification information transmitted by the identification sensor 143.

The storage 170 may store therein information on the type of aerosol-generating article 200 corresponding to the identification information generated by the identification sensor 143. The information on the type of aerosol-generating article 200 may include the thickness of the aerosol-generating article 200, the length and volume of the tobacco rod 210 of the aerosol-generating article 200, the amount of aerosol-generating material contained in the aerosol-generating article 200, the presence or absence of a susceptor in the aerosol-generating article 200, and the length and thickness of the thermally conductive wrapper 250. However, the information on the type of aerosol-generating article is not limited thereto, and may include any of various pieces of information related to the characteristics of the aerosol-generating article 200 as needed.

The controller 110 may heat the aerosol-generating material in the first section based on the identified type of aerosol-generating article 200. The controller 110 may determine whether the thermally conductive wrapper 250 is included in the aerosol-generating article according to the identified type of aerosol-generating article 200.

The heater 130 may include at least one of an induction heater or an electro-resistive heater.

For example, the heater 130 may be an electro-resistive heater. The controller 110 may control the amount of electric power supplied to the heater 130 such that the electro-resistive heater operates in the first section both in the case in which the identified aerosol-generating article 200 includes the thermally conductive wrapper 250 and in the case in which the identified aerosol-generating article 200 does not include the thermally conductive wrapper 250.

For example, the heater 130 may be an induction heater. In the case in which the identified aerosol-generating article 200 includes the thermally conductive wrapper 250, the controller 110 may control the amount of electric power supplied to the heater 130 such that the induction heater operates in the first section. In the case in which the identified aerosol-generating article 200 does not include the thermally conductive wrapper 250, the controller 110 may determine whether the identified aerosol-generating article 200 includes a susceptor. In the case in which the identified aerosol-generating article 200 includes a susceptor, the controller 110 may control the amount of electric power supplied to the heater 130 such that the induction heater operates in the first section.

For example, the heater 130 may include both an electro-resistive heater and an induction heater.

In the case in which the identified aerosol-generating article 200 includes the thermally conductive wrapper 250, the controller 110 may control the amount of electric power supplied to the heater 130 such that the induction heater operates in the first section. In the case in which the identified aerosol-generating article 200 does not include the thermally conductive wrapper 250, the controller 110 may control the amount of electric power supplied to the heater 130 such that the electro-resistive heater operates in the first section.

As described above, the heater included in the aerosol-generating device 100 is appropriately controlled according to the heating method thereof, thereby making it possible to remove moisture present in the aerosol-generating article using the conventional aerosol-generating device without a separate heating device.

The controller 110 may determine the first temperature and the first time period based on the identified type of aerosol-generating article 200, and may control the amount of electric power supplied to the heater 130. For example, as the thickness of the aerosol-generating article 200 increases, as the length or volume of the tobacco rod 210 increases, as the length of the thermally conductive wrapper 250 increases, or as the thickness of the thermally conductive wrapper 250 increases, the controller 110 may set at least one of the first temperature T1 or the first time period to a higher level, as shown in FIGS. 8 and 9. Also, as the thickness of the aerosol-generating article 200 decreases, as the length or volume of the tobacco rod 210 decreases, as the length of the thermally conductive wrapper 250 decreases, or as the thickness of the thermally conductive wrapper 250 decreases, the controller 110 may set at least one of the first temperature T1 or the first time period to a lower level, as shown in FIGS. 8 and 9.

As described above, the first temperature T1 and the first time period may be determined based on the type of aerosol-generating article 200, thereby making it possible to effectively remove moisture present in the aerosol-generating article 200.

FIGS. 11 and 12 are graphs showing the characteristics for controlling the supply of electric power to the heater in the first section according to embodiments of the present disclosure.

Referring to FIG. 11, the first section may include a heating section P1-1 and a maintenance section P1-2. The maintenance section P1-2 is a section located after the heating section P1-1 based on time. In the heating section P1-1, the controller 110 may apply a first magnitude of electric power Pwr1 to the heater 130 so that the temperature of the aerosol-generating material increases from the ambient temperature T0 or a temperature close to the same to the first temperature T1. In the maintenance section P1-2, after the heating section P1-1, the controller 110 may apply a second magnitude of electric power Pwr2 to the heater 130 so that the temperature of the aerosol-generating material is maintained constant at the first temperature T1 during the first time period. The second magnitude of electric power Pwr2 may be smaller than the first magnitude of electric power Pwr1.

The controller 110 may control the supply of electric power to the heater 130 based on the PID method during the heating section and the maintenance section. However, the method of supplying electric power to the heater 130 is not limited thereto.

Referring to FIG. 12, the first section may include a heating section P1-1, a first maintenance section P1-2a, and a second maintenance section P1-2b. The first maintenance section P1-2a is a section located after the heating section P1-1 based on time, and the second maintenance section P1-2b is a section located after the first maintenance section P1-2a based on time.

In the heating section P1-1, the controller 110 may apply a third magnitude of electric power Pwr3 to the heater 130 so that the temperature of the aerosol-generating material increases from the ambient temperature T0 or a temperature close to the same to the first temperature T1. The controller 110 may apply a large magnitude of electric power to the heater 130 within a short time period so that the temperature of the aerosol-generating material quickly reaches the first temperature T1.

In the first maintenance section P1-2a, after the heating section P1-1, the controller 110 may not supply electric power to the heater 130. In the second maintenance section P1-2b, after the first maintenance section P1-2a, the controller 110 may apply the second magnitude of electric power Pwr2 to the heater 130.

When a large magnitude of electric power is applied to the heater 130 during the heating section P1-1, the temperature of the aerosol-generating material may increase to a temperature higher than the first temperature P1. That is, when the temperature of the aerosol-generating material sharply increases, an overshoot may occur when the temperature of the aerosol-generating material reaches the first temperature T1. Therefore, the controller 110 may perform control such that electric power is not supplied to the heater 130 in the first maintenance section P1-2a, thereby causing the temperature of the aerosol-generating material to sharply increase from the ambient temperature T0 to the first temperature T1 and minimizing the overshoot of the first temperature T1.

Accordingly, the length of the first section may be minimized, and the temperature of the aerosol-generating material may be maintained constant at the first temperature during the first section.

The controller 110 may control the supply of electric power to the heater 130 based on the PWM method during the heating section and the maintenance section. The controller 110 may control the supply of electric power to the heater 130 based on the PWM method in the heating section and based on the PID method in the maintenance section. However, the method of supplying electric power to the heater 130 is not limited thereto.

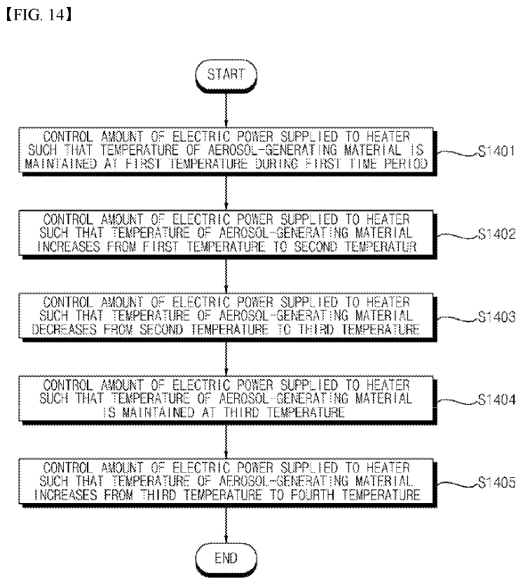

FIGS. 13 and 14 are flowcharts of a heater control method of the aerosol-generating device according to embodiments of the present disclosure.

Referring to FIG. 13, when a request for generation of an aerosol occurs, the aerosol-generating device 100 controls the amount of electric power supplied to the heater such that the aerosol-generating material is heated to the first temperature and the temperature of the aerosol-generating material is maintained constant at the first temperature during the first time period in the first section (S1101). Here, the first temperature may be higher than the ambient temperature. The first temperature may be lower than the volatilization temperature of the aerosol-generating material. The first temperature and the first time period may be determined based on ambient humidity. The first temperature and the first time period may be determined based on the identified type of aerosol-generating article. Operation S1101 may be omitted when the ambient humidity is equal to or less than a preset value.

In the second section, after the first section, the aerosol-generating device 100 controls the amount of electric power supplied to the heater such that the temperature of the aerosol-generating material increases to the second temperature, which is higher than the first temperature (S1102).

In the third section, after the second section, the aerosol-generating device 100 controls the amount of electric power supplied to the heater such that the temperature of the aerosol-generating material decreases from the second temperature to the third temperature (S1103).

Thereafter, in the third section, the aerosol-generating device 100 controls the amount of electric power supplied to the heater such that the temperature of the aerosol-generating material is maintained at the third temperature (S1104).

In operation S1104, when the number of user puffs is equal to or larger than a predetermined number of times, or when a predetermined time period has elapsed since the aerosol-generating material started to be heated toward the first temperature (since the first section started), the aerosol-generating device 100 may interrupt the supply of electric power to the heater in order to stop heating the aerosol-generating material.

Referring to FIG. 14, the aerosol-generating device 100 controls the amount of electric power supplied to the heater such that the aerosol-generating material is heated to the first temperature and the temperature of the aerosol-generating material is maintained constant at the first temperature during the first time period in the first section (S1201). Here, the first temperature may be higher than the ambient temperature. The first temperature may be lower than the volatilization temperature of the aerosol-generating material. The first temperature and the first time period may be determined based on ambient humidity. The first temperature and the first time period may be determined based on the identified type of aerosol-generating article. Operation S1201 may be omitted when the ambient humidity is equal to or less than a preset value.

In the second section, after the first section, the aerosol-generating device 100 controls the amount of electric power supplied to the heater such that the temperature of the aerosol-generating material increases to the second temperature, which is higher than the first temperature (S1202).

In the third section, after the second section, the aerosol-generating device 100 controls the amount of electric power supplied to the heater such that the temperature of the aerosol-generating material decreases from the second temperature to the third temperature (S1203).

Thereafter, in the third section, the aerosol-generating device 100 controls the amount of electric power supplied to the heater such that the temperature of the aerosol-generating material is maintained at the third temperature (S1204).

In the fourth section, after the third section, the aerosol-generating device 100 controls the amount of electric power supplied to the heater such that the temperature of the aerosol-generating material gradually increases to the fourth temperature, which is higher than the third temperature (S1205).

In operation S1204 or operation S1205, when the number of user puffs is equal to or larger than a predetermined number of times, or when a predetermined time period has elapsed since the aerosol-generating material started to be heated toward the first temperature (since the first section started), the aerosol-generating device 100 may interrupt the supply of electric power to the heater in order to stop heating the aerosol-generating material.

The embodiments of the present disclosure described above may be implemented through computer programs executable through various components on a computer, and such computer programs may be recorded in a computer-readable recording medium. Here, the computer-readable recording medium may include a magnetic medium such as a hard disc, a floppy disc, and a magnetic tape, an optical recording medium such as CD-ROM and DVD, a magneto-optical medium such as a floptical disc, and a hardware device specially configured to store and execute program code, such as ROM, RAM, SSD, and flash memory.

The computer programs may be specially designed and constructed for the purposes of the present disclosure, or may be of a kind that is well-known and available to those skilled in the computer software art. Examples of the computer program may include not only machine language code generated by compilers but also high-level language code that can be executed by computers using interpreters.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a heater configured to heat an aerosol-generating material;
a power supply configured to supply electric power to the heater; and
a controller configured to control the electric power to be supplied to the heater,
wherein, in a first section, the controller is configured to control electric power to be supplied to the heater such that the aerosol-generating material is heated to a first temperature during a first time period,
wherein, in a second section after the first section, the controller is configured to control electric power to be supplied to the heater such that the aerosol-generating material is heated to a second temperature higher than the first temperature, and
wherein, in a third section after the second section, the controller is configured to control electric power to be supplied to the heater such that the aerosol-generating material is maintained at a third temperature lower than the second temperature.

2. The aerosol-generating device according to claim 1, wherein the first temperature is higher than an ambient temperature and lower than a volatilization temperature of the aerosol-generating material.

3. The aerosol-generating device according to claim 1, further comprising:
a humidity sensor configured to measure an ambient humidity,
wherein the controller is configured to determine the first temperature and the first time period based on the ambient humidity measured by the humidity sensor.

4. The aerosol-generating device according to claim 3, wherein based on increase in the ambient humidity, the controller is configured to increase at least one of the first temperature or the first time period.

5. The aerosol-generating device according to claim 3, wherein based on the ambient humidity being less than or equal to a preset value, the controller is configured to omit control in the first section and perform control for heating the aerosol-generating material to the second temperature in the second section.

6. The aerosol-generating device according to claim 1, further comprising:
an identification sensor,
wherein the controller is configured to identify an aerosol-generating article containing the aerosol-generating material based on a signal of the identification sensor.

7. The aerosol-generating device according to claim 6, wherein the controller is configured to determine the first temperature and the first time period based on a type of the identified aerosol-generating article.

8. The aerosol-generating device according to claim 6, wherein the heater comprises at least one of an induction heater or an electro-resistive heater, and
wherein the controller is configured to control an amount of electric power supplied to the induction heater or the electro-resistive heater based on a type of the identified aerosol-generating article.

9. The aerosol-generating device according to claim 8, wherein the controller is configured to determine whether the identified aerosol-generating article comprises a thermally conductive wrapper according to the type of the identified aerosol-generating article, and
wherein based on the identified aerosol-generating article being determined to comprise the thermally conductive wrapper, the controller is configured to perform control such that the induction heater is heated.

10. The aerosol-generating device according to claim 8, wherein the controller is configured to determine whether the identified aerosol-generating article comprises a thermally conductive wrapper according to the type of the identified aerosol-generating article, and
wherein based on the identified aerosol-generating article being determined not to comprise the thermally conductive wrapper, the controller is configured to perform control such that the electro-resistive heater is heated.

11. The aerosol-generating device according to claim 1, wherein in a fourth section after the third section, the controller is configured to control an amount of electric power supplied to the heater such that the aerosol-generating material is gradually heated to a fourth temperature higher than the third temperature.

12. The aerosol-generating device according to claim 1, further comprising:
a flow sensor or a pressure sensor,
wherein the controller is configured to sense a number of user puffs via the flow sensor or the pressure sensor, and
wherein based on the number of user puffs being greater than or equal to a predetermined number of times, or based on a second time period elapsing since heating the aerosol-generating material to the first temperature started, the controller is configured to stop supply of electric power to the heater to stop heating the aerosol-generating material.

13. The aerosol-generating device according to claim 1, wherein the first section comprises a heating section and a maintenance section following the heating section,
wherein the maintenance section comprises a first maintenance section and a second maintenance section following the first maintenance section,
wherein in the heating section, the controller is configured to perform control such that a first magnitude of electric power is supplied to the heater to heat the aerosol-generating material to the first temperature,
wherein in the first maintenance section, the controller is configured to perform control such that electric power is not supplied to the heater,
wherein in the second maintenance section, the controller is configured to perform control such that a second magnitude of electric power is supplied to the heater, and
wherein the second magnitude of electric power is smaller than the first magnitude of electric power.

14. The aerosol-generating device according to claim 1, wherein the controller is configured to determine whether an event related to generation of the aerosol occurs, and perform control for heating the aerosol-generating material to the first temperature during the first time period in the first section in response to determination that the event related to generation of the aerosol occurs.

15. An aerosol-generating system comprising:
an aerosol-generating article containing an aerosol-generating material; and
an aerosol-generating device configured to heat the aerosol-generating material,
wherein the aerosol-generating device comprises:
a heater configured to heat the aerosol-generating material;
a power supply configured to supply electric power to the heater; and
a controller configured to control the electric power to be supplied to the heater,
wherein in a first section, the controller is configured to control electric power to be supplied to the heater such that the aerosol-generating material is heated to a first temperature during a first time period,
wherein in a second section after the first section, the controller is configured to control electric power to be supplied to the heater such that the aerosol-generating material is heated to a second temperature higher than the first temperature, and
wherein in a third section after the second section, the controller is configured to control electric power to be supplied to the heater such that the aerosol-generating material is maintained at a third temperature lower than the second temperature.
